(19) United States
(12) Patent Application Publication
(10) Pub. No.: US 2015/0106666 A1
(43) Pub. Date: Apr. 16, 2015

(54) Speculative Bit Error Rate Calculator

(71) Applicant: LSI Corporation, San Jose, CA (US)

(72) Inventors: Alexander Hubris, Milpitas, CA (US); Vidyuth Srivatsaa, San Jose, CA (US); Bing Ji, San Jose, CA (US)

(73) Assignee: LSI Corporation, San Jose, CA (US)

(21) Appl. No.: 14/052,732

(22) Filed: Oct. 12, 2013

Related U.S. Application Data
(60) Provisional application No. 61/889,527, filed on Oct. 10, 2013.

(51) Int. Cl. G06F 11/07

(52) U.S. Cl. CPC G06F 11/076
USPC 714/704

(57) ABSTRACT

An apparatus for calculating a speculative bit error rate includes a data decoder operable to iteratively decode received data to yield decoded data, and a speculative bit error calculator operable to calculate a bit error rate based on the decoded data and the received data while the data decoder is decoding the received data. The bit error rate is updated with each decoding iteration in the data decoder.

### CROSS REFERENCE TO RELATED APPLICATIONS

The present application claims priority to (is a non-provisional of) U.S. Pat. App. No. 61/889,527, entitled “Speculative Bit Error Rate Calculator”, and filed Oct. 10, 2013 by Hubris et al, the entirety of which is incorporated herein by reference for all purposes.

### FIELD OF THE INVENTION

Various embodiments of the present invention provide systems and methods for speculatively calculating bit error rate during decoding.

### BACKGROUND

Various data processing systems have been developed including storage systems, cellular telephone systems, and radio transmission systems. In such systems data is transferred from a sender to a receiver via some medium. For example, in a storage system, data is sent from a sender (i.e., a write function) to a receiver (i.e., a read function) via a storage medium. As information is stored and transmitted in the form of digital data, errors are introduced that, if not corrected, can corrupt the data and render the information unusable. The effectiveness of any transfer is impacted by any losses in data caused by various factors. Data can be encoded before transmission or storage, for example adding parity bits. The retrieved data can then be decoded to detect and correct errors.

### BRIEF SUMMARY

Some embodiments of the present invention provide an apparatus for calculating a speculative bit error rate, comprising a data decoder operable to iteratively decode received data to yield decoded data, and a speculative bit error calculator operable to calculate a bit error rate based on the decoded data and the received data while the data decoder is decoding the received data. The bit error rate is updated with each decoding iteration in the data decoder.

This summary provides only a general outline of some embodiments according to the present invention. Many other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components.

FIG. 1 depicts a decoding pipeline with speculative bit error rate calculation in accordance with some embodiments of the present invention;

FIG. 2 depicts a speculative bit error rate calculator in accordance with some embodiments of the present invention;

FIG. 3 depicts a speculative bit error rate calculator for use with a layer decoder and which distinguishes between error polarity in accordance with some embodiments of the present invention;

FIG. 4 depicts a flow diagram of an operation for speculatively calculating bit error rate as data is decoded in a layer decoder in accordance with one or more embodiments of the present invention;

FIG. 5 depicts a storage system including a read channel having a speculative bit error rate calculator in accordance with some embodiments of the present invention;

FIG. 6 depicts a wireless communication system including a receiver having a speculative bit error rate calculator in accordance with some embodiments of the present invention; and

FIG. 7 depicts another storage system including a data processing circuit having a speculative bit error rate calculator in accordance with some embodiments of the present invention.

### DETAILED DESCRIPTION OF THE INVENTION

Embodiments of the present invention are related to speculatively calculating bit error rate during decoding. The speculative bit error rate calculation disclosed herein is performed as data is iteratively decoded, based on the decoded data, also referred to herein as hard decisions, that are generated and updated as the data is decoded. With each decoding iteration, the decoded data is updated and can be changed as errors are detected and corrected. The speculative bit error rate is also updated during this process, using delta values or differences detected from one decoding iteration to the next. The bit error rate is thus made available immediately or soon after decoding converges on stable or correct values, or after the maximum number of decoding iterations have been performed and decoding is terminated. In this manner, the bit error rate is calculated without waiting for decoding to be completed and stored. In some embodiments, this saves a codeword or more of latency by calculating the bit error rate in the decoding stage rather than the output stage of the decoding pipeline.

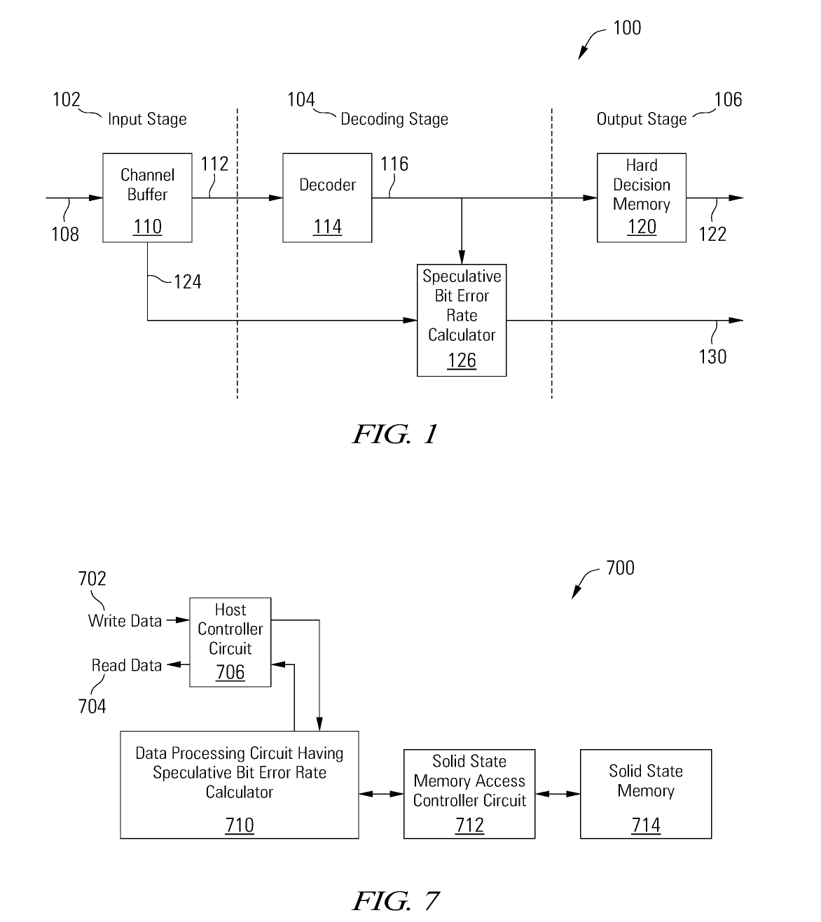

Turning to FIG. 1, a decoding pipeline 100 with a speculative bit error rate calculator 126 is shown in accordance with some embodiments of the invention. In an input stage 102, data 108 to be decoded is stored in a channel buffer 110. Buffered data 112 is provided to a decoder 114, which applies a data decoding algorithm to yield decoded data 116. As the decoder 114 is decoding, a speculative bit error calculator 126 speculatively calculates the bit error rate of the data 108, based on buffered input data 124 and the decoded data 116 as it is updated by the decoder 114. Notably, in some embodiments the speculative bit error calculator 126 is in the decoding stage 104 of the pipeline 100 with the decoder 114, operating during the decoding rather than after decoding is complete in the output stage 106. When decoding completes, either when data converges or the maximum number of decoding iterations have been performed in decoder 114, the decoded data stored in hard decision memory 120 is provided at output 122, and the speculatively calculated bit error rate 130 is also output.

Speculative bit error rate calculation is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In some embodiments, the data decoding algorithm can be but is not limited to, a low density parity check decoding algorithm as is known in the art. Based upon the disclosure provided herein, one of ordinary skill in the art will recognize a variety of data decoding algorithms that may be used in relation to different embodiments of the present invention. A low density parity check code is defined by a sparse parity check matrix H of size m×n, where m<n. A codeword c of length n satisfies all the m parity check equations defined by H, i.e., cH^{T}=0, where 0 is a zero vector. Decoder convergence is checked by determining whether the syndrome s=cH^{T} is all zero, where the syndrome is a vector of length m, with each bit corresponding to a parity check. A zero bit in a syndrome means the check is satisfied, while a non-zero bit in the syndrome is an unsatisfied check (USC). By definition, a codeword has syndrome s=0. A non-codeword has a non-zero syndrome.

In some embodiments, the data decoding algorithm is a layered quasi-cyclic low density parity check decoding algorithm, in which the parity check matrix H is divided into layers, and the codeword is decoded layer by layer. In some of these embodiments, data can converge and decoding can be finished as a layer is decoded partway through a decoding iteration, without having to complete decoding of all layers in the parity check matrix H. Speculative bit error rate calculation can be completed in these embodiments as soon as data converges, also without having to complete decoding of all layers in the parity check matrix H.

Effectively, the speculative bit error rate calculation is performed while processing each of the layers in the decoder 114. The bit error rate is tabulated and retained layer by layer, iteration by iteration in the speculative bit error rate calculator 126. As each layer is decoded, the delta value is calculated and accumulated by layer, retaining the values so that the bit error rate can be speculatively accumulated. If the decoder converges, the total accumulated value based on the deltas will be used as the final bit error rate for the decoded data. By performing this delta accumulation, the speculative bit error rate calculator 126 can generate the total bit error rate at the decoding stage 104 rather than waiting until the final output stage 106 to calculate the bit error rate.

In embodiments in which the decoder 114 is a non-layer decoder, the deltas are calculated iteration by iteration as the decoding process progresses, without differentiating by layer. In some of these embodiments, convergence is not detected until the end of a decoding iteration, and the speculative bit error rate calculation is performed at the end of each decoding iteration.

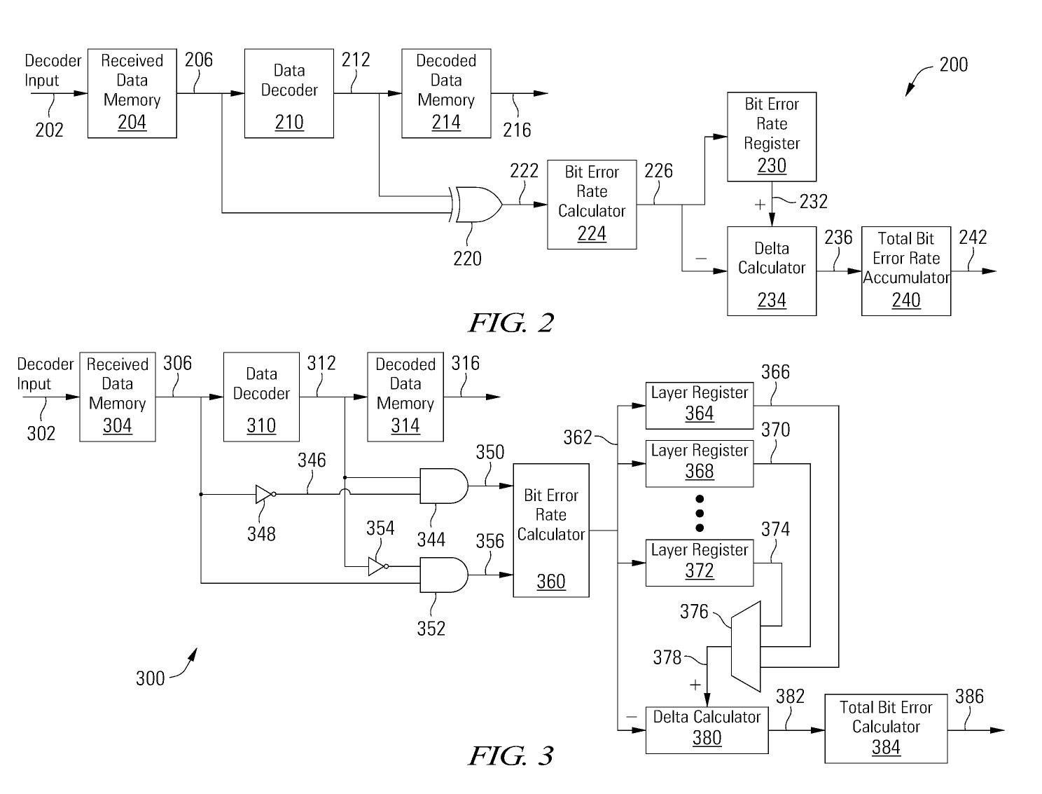

Turning to FIG. 2, a speculative bit error rate calculator 200 is shown in accordance with some embodiments of the present invention. In the embodiment shown in FIG. 2, the speculative bit error rate calculator 200 does not distinguish between different types of errors. In other embodiments, the speculative bit error rate calculator distinguishes between types of errors, such as, but not limited to, expecting a 1 but receiving a 0, and expecting a 0 but receiving a 1. The speculative bit error rate calculator 200 can be used with either a layer or non-layer decoder. Other embodiments, such as that shown in FIG. 3, are adapted for use specifically with a layer decoder, and can output the final bit error rate after decoding any layer, as soon as decoding converges, without finishing the decoding iteration.

Data 202 to be decoded is received and stored in received data memory 204. In some embodiments, the data 202 to be decoded comprises data encoded using a low density parity check encoding algorithm. In some embodiments, the data to be decoded is obtained as soft decisions, also referred to as soft data. As used herein, the phrase “soft data” is used in its broadest sense to mean reliability data with each instance of the reliability data indicating a likelihood that a bit or symbol has been correctly detected. In some embodiments of the present invention, the soft data or reliability data is log likelihood ratio data as is known in the art. In some embodiments, the data to be decoded is obtained directly or indirectly from a data detector that applies a data detection algorithm to sampled data from an analog to digital converter. In some embodiments, the data detection algorithm can be but is not limited to, a Viterbi algorithm detection algorithm or a maximum a posteriori detection algorithm as are known in the art. Based upon the disclosure provided herein, one of ordinary skill in the art will recognize a variety of data detection algorithms that may be used in relation to different embodiments of the present invention.

The received data 206 is provided to data decoder 210, which applies a data decoding algorithm to received data 206 to yield decoded data 212. (Although the data decoder 210 is shown as part of the speculative bit error rate calculator 200, in various embodiments the data decoder 210 and speculative bit error rate calculator 200 can be separate elements or considered separate elements of an overall apparatus.) it can be either included In some embodiments, the decoder is a low density parity check decoding algorithm as is known in the art. Based upon the disclosure provided herein, one of ordinary skill in the art will recognize a variety of data decoding algorithms that may be used in relation to different embodiments of the present invention. The decoded data 212 is stored in a decoded data memory 214 before being provided at output 216 after convergence or termination of failed decoding.

An array of XOR gates 220, also referred to herein as a failed expectation detector, detects differences between the decoded data 212 and the received data 206, yielding bit error signal 222. In some embodiments, the decoder 210 is a quasi-cyclic low density parity check decoder, processing 128-bit wide circulant sub-matrices of the parity check matrix H. In some of these embodiments, the decoded data 212 is 128 bits wide, and the array of XOR gates 220 includes 128 XOR gates, each comparing one bit of the 128 bits of decoded data 212 with a corresponding bit of the received data 206. The bit error signal 222 then contains 128 bits in unary notation, each with a value of 1 when their corresponding bit of decoded data 212 and received data 206 are different. However, the decoded data 212 is not limited to a bit width of 128 bits. In non-layered embodiments, the decoded data 212 can correspond to other portions of a codeword, up to and including an entire codeword.

A per iteration bit error rate calculator 224 counts the number of failed expectations, based on the number of 1's in bit error signal 222, yielding a per layer bit error rate, also referred to herein as a failed expectation count 226. In some embodiments, the failed expectation count 226 is represented as a 7-bit binary number with a maximum value of 128, in the case in which all 128 bits of decoded data 212 differ from the corresponding 128 bits of received data 206. The bit error rate calculator 224 can include any suitable circuit for counting the number of 1's in bit error signal 222 or otherwise generating a failed expectation count 226. Based upon the disclosure provided herein, one of ordinary skill in the art will recognize a variety of counting circuits that may be used in bit error rate calculator 224 in relation to different embodiments of the present invention.

A delta calculator 234 calculates the difference between the failed expectation count 226 calculated in the current decoding iteration and that calculated in the previous decoding iteration as stored in a bit error rate register 230. For the first decoding iteration, the bit error rate register 230 is initialized at zero. In embodiments with a layered decoder 210, the bit error rate register 230 is divided by layer, and is operable to store the previous iteration failed expectation count 226 for each layer.

In some embodiments, the delta calculator 234 is operable to subtract the failed expectation count 226 for the current iteration from the bit error rate calculator 224 from the failed expectation count 232 for the previous iteration from the bit error rate register 230, yielding delta value 236. The delta calculator 234 can contain any suitable circuit for calculating the difference between the failed expectation count 226 and previous iteration failed expectation count 232, such as, but not limited to, a subtraction circuit. Based upon the disclosure provided herein, one of ordinary skill in the art will recognize a variety of delta calculator circuits that may be used in relation to different embodiments of the present invention.

A total bit error rate accumulator 240 is initialized at zero at the beginning of a decoding operation, and is updated each time a delta value 236 is calculated. In some embodiments, the total bit error rate accumulator 240 is updated by subtracting the delta value 236 from the contents of the total bit error rate accumulator 240 and storing the result in the total bit error rate accumulator 240. In other embodiments, the total bit error rate accumulator 240 is updated by adding the delta value 236 from the contents of the total bit error rate accumulator 240 and storing the result in the total bit error rate accumulator 240, and then taking the absolute value of the contents of the total bit error rate accumulator 240 after decoding converges.

Once decoding converges, or when the maximum number of decoding iterations have been performed, the contents of the total bit error rate accumulator 240 are output as the final bit error rate 242.

As an example, assume that the data 202 to be decoded contains 8 erroneous bits. If in the first decoding iteration the decoded data 212 differs from the received data 206 by 5 bits, such as if 5 of the 8 erroneous bits were corrected during decoding, the bit error signal 222 will contain 5 bits with a value of 1. The failed expectation count 226 will be 5. The delta calculator 234 subtracts 5 (failed expectation count 226) from 0 (the initial value of the failed expectation count 232 stored in bit error rate register 230), yielding a delta value of −5. The delta value of −5 is subtracted from 0, the initial value in the total bit error rate accumulator 240, and the result is stored in the accumulator 240 for a total speculative bit error rate value of 5. The failed expectation count 226 of 5 is stored in bit error rate register 230 for the next decoding iteration.

If in the second decoding iteration the decoded data 212 differs from the received data 206 by 7 bits, such as if 2 more of the 8 erroneous bits were corrected during the second decoding iteration, the bit error signal 222 will contain 7 bits with a value of 1. The failed expectation count 226 will be 7. The delta calculator 234 subtracts 7 (failed expectation count 226) from 5 (the previous iteration failed expectation count 232), yielding a delta value of −2. The delta value of −2 is subtracted from 5, the value in the total bit error rate accumulator 240, and the result is stored in the accumulator 240 for a total speculative bit error rate value of 7. The failed expectation count 226 of 7 is stored in bit error rate register 230 for the next decoding iteration.

If in the third decoding iteration the decoded data 212 differs from the received data 206 by 6 bits, such as if one of the previously corrected bits fluctuates back to the incorrect value, the bit error signal 222 will contain 6 bits with a value of 1. The failed expectation count 226 will be 6. The delta calculator 234 subtracts 6 (failed expectation count 226) from 7 (the previous iteration failed expectation count 232), yielding a delta value of 1. The delta value of 1 is subtracted from 7, the value in the total bit error rate accumulator 240, and the result is stored in the accumulator 240 for a total speculative bit error rate value of 6. The failed expectation count 226 of 6 is stored in bit error rate register 230 for the next decoding iteration.

If in the fourth decoding iteration the decoded data 212 differs from the received data 206 by 8 bits, such as if all erroneous bits have been corrected, the bit error signal 222 will contain 8 bits with a value of 1. The failed expectation count 226 will be 8. The delta calculator 234 subtracts 8 (failed expectation count 226) from 6 (the previous iteration failed expectation count 232), yielding a delta value of −2. The delta value of −2 is subtracted from 6, the value in the total bit error rate accumulator 240, and the result is stored in the accumulator 240 for a total speculative bit error rate value of 8. If all data has converged in the decoder, the value of 8 in the accumulator 240 is output as the total bit error rate.

Turning to FIG. 3, a speculative bit error rate calculator 300 for use with a layer decoder and which distinguishes between error polarity is shown in accordance with some embodiments of the present invention. The speculative bit error rate calculator 300 distinguishes between two types of errors, one in which a bit is expected to be a 1 based on the decoded data but a 0 was received, and another in which a bit is expected to be a 0 based on the decoded data but a 1 was received. The speculative bit error rate calculator 300 is adapted for use with a layer decoder 310, and can output the final bit error rate after decoding any layer, as soon as decoding converges, without finishing the decoding iteration.

Data 302 to be decoded is received and stored in received data memory 304. In some embodiments, the data 302 to be decoded comprises data encoded using a low density parity check encoding algorithm. In some embodiments, the data to be decoded is obtained as soft decisions, also referred to as soft data. As used herein, the phrase “soft data” is used in its broadest sense to mean reliability data with each instance of the reliability data indicating a likelihood that a bit or symbol has been correctly detected. In some embodiments of the present invention, the soft data or reliability data is log likelihood ratio data as is known in the art. In some embodiments, the data to be decoded is obtained directly or indirectly from a data detector that applies a data detection algorithm to sampled data from an analog to digital converter. In some embodiments, the data detection algorithm can be but is not limited to, a Viterbi algorithm detection algorithm or a maximum a posteriori detection algorithm as are known in the art. Based upon the disclosure provided herein, one of ordinary skill in the art will recognize a variety of data detection algorithms that may be used in relation to different embodiments of the present invention.

The received data 306 is provided to data decoder 310, which applies a data decoding algorithm to received data 306 to yield decoded data 312. In some embodiments, the decoder is a quasi-cyclic layered low density parity check decoding algorithm as is known in the art. Based upon the disclosure provided herein, one of ordinary skill in the art will recognize a variety of data decoding algorithms that may be used in relation to different embodiments of the present invention. The decoded data 312 is stored in a decoded data memory 314 before being provided at output 316 after convergence or termination of failed decoding.

A failed expectation detector for detecting a first type of error (expected 1, received 0) includes an array of inverters 348 and AND gates 344. AND gates 344 compare bits in decoded data 312 with inverted copies 346 of corresponding bits in received data 306, inverted in inverters 348, yielding type 1 bit error signal 350. A failed expectation detector for detecting a second type of error (expected 0, received 1) includes an array of inverters 354 and AND gates 352. AND gates 352 compare bits in decoded data 312 with inverted copies 356 of corresponding bits in received data 306, inverted in inverters 354, yielding type 2 bit error signal 356. In some embodiments, the decoder 310 is a quasi-cyclic low density parity check decoder, processing 128-bit wide circulant sub-matrices of the parity check matrix H. In some of these embodiments, the decoded data 312 is 128 bits wide, and the type 1 bit error signal 350 and type 2 bit error signal 356 are each 128 bits wide, with the type 1 bit error signal 350 containing a high bit for each instance of a type 1 (expected 1, received 0) error, and with the type 2 bit error signal 356 containing a high bit for each instance of a type 2 (expected 0, received 1) error.

A bit error rate calculator 360 counts the number of each type of error or failed expectation, based on the number of 1's in bit error signals 350 and 356, yielding per layer bit error rates for each type of error, also referred to herein as a failed expectation count 362. In some embodiments, the failed expectation count 362 is represented as a pair of 7-bit binary numbers each with a maximum value of 128, and where the combined count of both types of errors would have a maximum value of 128. The bit error rate calculator 360 can include any suitable circuit for counting the number of 1's in bit error signals 350 and 356 or otherwise generating a failed expectation count 362. Based upon the disclosure provided herein, one of ordinary skill in the art will recognize a variety of counting circuits that may be used in bit error rate calculator 360 in relation to different embodiments of the present invention.

An array of bit error rate layer registers 364, 368, 372 is provided to store the failed expectation counts 362 for each layer. In some embodiments, one bit error rate layer register 364, 368, 372 is provided for each layer of the parity check matrix H, each containing a 7-bit count of both types of errors. The bit error rate layer registers 364, 368, 372 are initialized with a value of 0 for both types of errors at the beginning of a decoding operation.

A delta calculator 380 calculates the difference between the current layer failed expectation counts 362 calculated in the current decoding iteration and that calculated in the previous decoding iteration as stored in bit error rate layer registers 364, 368, 372. The previous iteration failed expectation counts 366, 370, 374 for the current layer are selected by multiplexer 376 and provided as current layer previous iteration failed expectation count 378 to the delta calculator 380.

The delta calculator 334 is operable to subtract the current layer current iteration failed expectation count 362 from the current layer previous iteration failed expectation count 378, yielding delta value 382. The delta value 382 contains a count of the difference in the number of each type of error between the current decoding iteration and the previous decoding iteration. The delta calculator 380 can contain any suitable circuit for calculating the difference between the counts 362, 378, such as, but not limited to, a subtraction circuit. Based upon the disclosure provided herein, one of ordinary skill in the art will recognize a variety of delta calculator circuits that may be used in relation to different embodiments of the present invention.

A total bit error rate accumulator 384 is initialized at zero at the beginning of a decoding operation, and is updated each time a delta value 382 is calculated. In some embodiments, the total bit error rate accumulator 384 is updated by subtracting the delta value 382 for each type of error from the contents of the total bit error rate accumulator 384 for that type of error and storing the result in the total bit error rate accumulator 384. In other embodiments, the total bit error rate accumulator 384 is updated by adding the delta value 382 for each type of error from the contents of the total bit error rate accumulator 384 for that type of error and storing the result in the total bit error rate accumulator 384, and then taking the absolute values of the contents of the total bit error rate accumulator 384 after decoding converges. The total bit error rate accumulator 384 thus contains a total count of the number of type 1 (expected 1, received 0) errors, and a total count of the number of type 2 (expected 0, received 1) errors. The total bit error rate for each type of error can be added before output, and can thus provide as output 386 both the total bit error rate for all types of errors, and the total bit error rate for each different type of error.

As an example, assume that the data 302 to be decoded contains 4 erroneous bits, 3 of type 1 (expected 1, received 0), and 1 of type 2 (expected 0, received 1). For simplicity, only errors in the first layer are considered in this example. If in the first decoding iteration the layer 1 decoded data 312 differs from the received data 306 by 2 bits for type 1 and 1 bit for type 2, such as if 2 of the type 1 errors and the single type 2 error were corrected during decoding, the type 1 bit error signal 350 will contain 2 bits with a value of 1 and the type 2 bit error signal 356 will contain 1 bit with a value of 1. The failed expectation count 362 will be 2 for type 1 and 1 for type 2. The delta calculator 380 subtracts 2 (the type 1 current layer current iteration failed expectation count 362) from 0 (the initial value of the type 1 current layer failed expectation count in layer register 364), yielding a type 1 delta value of −2. The delta value of −2 is subtracted from 0, the initial type 1 value in the total bit error rate accumulator 384, and the result is stored in the accumulator 384 for a total speculative type 1 bit error rate value of 2. The type 1 failed expectation count 362 of 2 is stored in layer register 364 for the next decoding iteration. The delta calculator 380 subtracts 1 (the type 2 current layer current iteration failed expectation count 362) from 0 (the initial value of the type 2 current layer failed expectation count in layer register 364), yielding a type 2 delta value of −1. The delta value of −1 is subtracted from 0, the initial type 2 value in the total bit error rate accumulator 384, and the result is stored in the accumulator 384 for a total speculative type 2 bit error rate value of 1. The type 2 failed expectation count 362 of 1 is stored in layer register 364 for the next decoding iteration. Again, the speculative bit error rate calculation for other layers in the first decoding iteration is omitted from consideration for simplicity.

If in the second decoding iteration the layer 1 decoded data 312 differs from the received data 306 by 3 bits for type 1 and 1 bit for type 2, such as if all errors were corrected during decoding, the type 1 bit error signal 350 will contain 3 bits with a value of 1 and the type 2 bit error signal 356 will contain 1 bit with a value of 1. The failed expectation count 362 will be 3 for type 1 and 1 for type 2. The delta calculator 380 subtracts 3 (the type 1 current layer current iteration failed expectation count 362) from 2 (the previous iteration type 1 count in layer register 364), yielding a type 1 delta value of −1. The delta value of −1 is subtracted from 2, the type 1 value in the total bit error rate accumulator 384, and the result is stored in the accumulator 384 for a total speculative type 1 bit error rate value of 3. The type 1 failed expectation count 362 of 3 is stored in layer register 364 for the next decoding iteration. The delta calculator 380 subtracts 1 (the type 2 current layer current iteration failed expectation count 362) from 1 (the previous iteration type 2 count in layer register 364), yielding a type 2 delta value of 0. The delta value of 0 is subtracted from 0, the previous type 2 value in the total bit error rate accumulator 384, and the result is stored in the accumulator 384, leaving an unchanged total speculative type 2 bit error rate value of 1. The type 2 failed expectation count 362 of 1 is stored in layer register 364 for the next decoding iteration.

In some embodiments, if all data has converged in the decoder, the type 1 value of 3 in the accumulator 384 is output as the total type 1 bit error rate, the type 2 value of 1 in the accumulator 384 is output as the total type 2 bit error rate, and the two are added and output to yield a total bit error rate of 4.

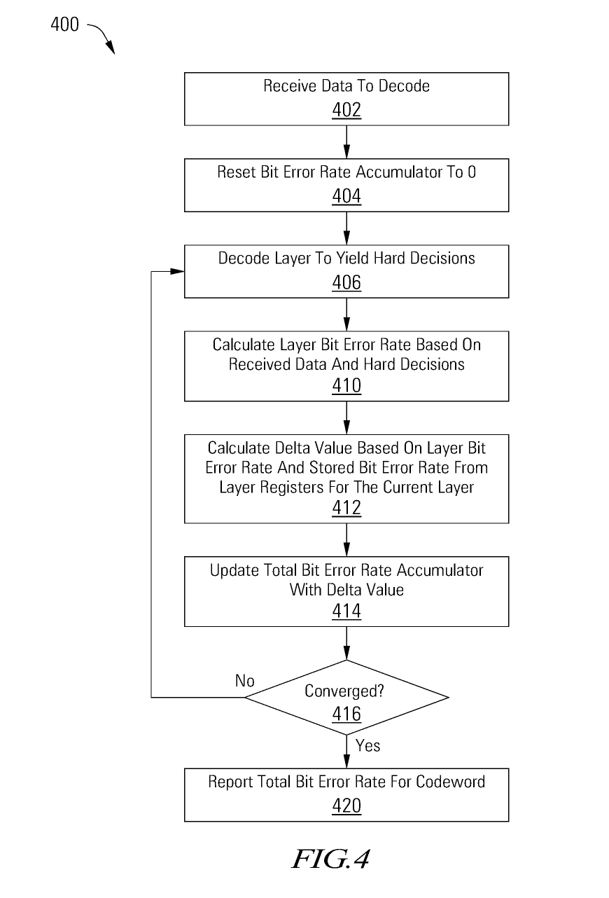

Turning to FIG. 4, a flow diagram 400 depicts a method for speculative bit error rate calculation in accordance with one or more embodiments of the present invention. The speculative bit error rate is calculated while data is being decoded, rather than after the decoding process is complete. This makes the bit error rate available immediately after data converges, finishing the decoding process. (Equivalently, the bit error rate can be made available immediately after the maximum number of decoding iterations have been performed.) The decoding process can be, but is not limited to, a layered iterative low density parity check decoding process, in which layers of an H matrix are decoded one by one. This can be performed in some embodiments in a quasi-cyclic layered low density parity check decoder. In some of these embodiments, the decoding can converge and complete after decoding any layer, without having to complete all layers of the H matrix in a decoding iteration.

Following flow diagram 400, data to be decoded is received. (Block 402) The data to be decoded is not limited to any particular format or source. In some embodiments, the data to be decoded comprises data encoded using a low density parity check encoding algorithm. In some embodiments, the data to be decoded is obtained as soft decisions, also referred to as soft data. As used herein, the phrase “soft data” is used in its broadest sense to mean reliability data with each instance of the reliability data indicating a likelihood that a bit or symbol has been correctly detected. In some embodiments of the present invention, the soft data or reliability data is log likelihood ratio data as is known in the art. In some embodiments, the data to be decoded is obtained directly or indirectly from a data detector that applies a data detection algorithm to sampled data from an analog to digital converter. In some embodiments, the data detection algorithm can be but is not limited to, a Viterbi algorithm detection algorithm or a maximum a posteriori detection algorithm as are known in the art. Based upon the disclosure provided herein, one of ordinary skill in the art will recognize a variety of data detection algorithms that may be used in relation to different embodiments of the present invention.

A total bit error rate accumulator and layer registers are initialized to zero at the beginning of the speculative bit error rate calculation and the decoding process. (Block 404) The current layer is decoded to yield hard decisions, also referred to herein as decoded data. (Block 406) The bit error rate for the current layer is calculated based on the received data and the hard decisions. (Block 410) In some embodiments, the bit error rate is calculated by detecting and counting the differences between the received data and the hard decisions. In some embodiments, the bit error rate calculation distinguishes between different types of errors, such as, but not limited to, an error in which a bit value of 0 was expected but a 1 was received, and an error in which a bit value of 1 was expected but a 0 was received. This is a speculative bit error rate calculation, because the data may not have converged at this point, and the hard decisions may not be the final, correct values.

A delta value for the layer is calculated based on the bit error rate just calculated and the stored bit error rate from the layer for the current layer. (Block 412) The stored bit error rate is either the initial value just calculated, if in the first decoding iteration, or the bit error rate calculated for the layer in the previous decoding iteration. In some embodiments, the delta value is calculated by subtracting the bit error rate just calculated from the bit error rate from the layer register, in other words, by subtracting the layer bit error rate from the current iteration from the layer bit error rate from the previous iteration. The total bit error rate accumulator is updated with the delta value. (Block 414) In some embodiments, this is accomplished by subtracting the delta value from the value in the accumulator and storing the result in the accumulator.

A determination is made as to whether the data has converged in the decoder. (Block 416) Notably, in a layer decoder, this can occur after decoding of any layer, making the decoded codeword and corresponding bit error rate available partway through a decoding iteration, without having to complete all the layers in the iteration. If the data has converged (or if the maximum number of iterations has been reached), the total bit error rate in the accumulator is reported. (Block 420) Otherwise, the decoding and speculative bit error rate calculation process continues. (Block 406) As hard decisions are changed during the decoding process, the total bit error rate value in the accumulator will change accordingly, updating the speculatively calculated bit error rate as the decoding progresses. This enables the correct bit error rate to be provided as soon as decoding has converged and the bit error rate delta update has been performed for the last layer that resulted in convergence.

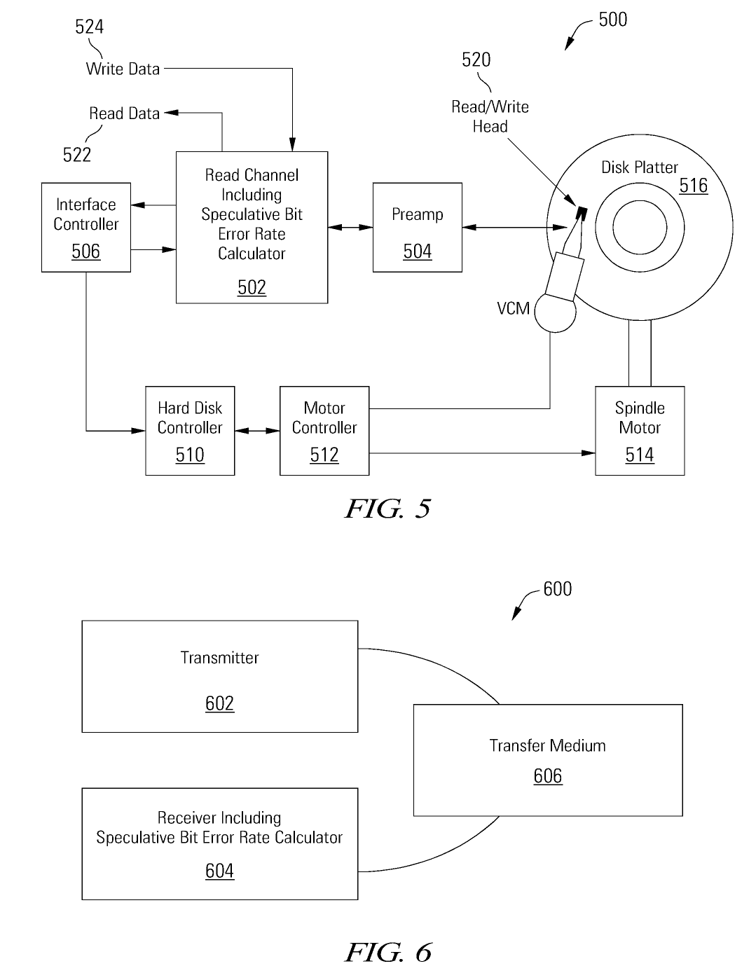

Turning to FIG. 5, a storage system 500 is illustrated as an example application of a speculative bit error rate calculator in accordance with some embodiments of the present invention. The storage system 500 includes a read channel circuit 502 with a speculative bit error rate calculator in accordance with one or more embodiments of the present invention. Storage system 500 may be, for example, a hard disk drive. Storage system 500 also includes a preamplifier 504, an interface controller 506, a hard disk controller 510, a motor controller 512, a spindle motor 514, a disk platter 516, and a read/write head assembly 520. Interface controller 506 controls addressing and timing of data to/from disk platter 516. The data on disk platter 516 consists of groups of magnetic signals that may be detected by read/write head assembly 520 when the assembly is properly positioned over disk platter 516. In one embodiment, disk platter 516 includes magnetic signals recorded in accordance with either a longitudinal or a perpendicular recording scheme.

In a typical read operation, read/write head assembly 520 is accurately positioned by motor controller 512 over a desired data track on disk platter 516. Motor controller 512 both positions read/write head assembly 520 in relation to disk platter 516 and drives spindle motor 514 by moving read/write head assembly 520 to the proper data track on disk platter 516 under the direction of hard disk controller 510. Spindle motor 514 spins disk platter 516 at a determined spin rate (RPMs). Once read/write head assembly 520 is positioned adjacent the proper data track, magnetic signals representing data on disk platter 516 are sensed by read/write head assembly 520 as disk platter 516 is rotated by spindle motor 514. The sensed magnetic signals are provided as a continuous, minute analog signal representative of the magnetic data on disk platter 516. This minute analog signal is transferred from read/write head assembly 520 to read channel circuit 502 via preamplifier 504. Preamplifier 504 is operable to amplify the minute analog signals accessed from disk platter 516. In turn, read channel circuit 502 digitizes and decodes the received analog signal to recreate the information originally written to disk platter 516. This data is provided as read data 522 to a receiving circuit. While processing the read data, read channel circuit 502 decodes the read data to detect and correct errors. A speculative bit error rate calculator speculatively calculates the bit error rate as the data is decoded, without having to wait for the decoding to complete. Such speculative bit error rate calculation can be implemented consistent with the disclosure above in relation to FIGS. 1-3. In some embodiments, the speculative bit error rate calculation can be performed consistent with a process disclosed above in relation to FIG. 4. A write operation is substantially the opposite of the preceding read operation with write data 524 being provided to read channel circuit 502. This data is then encoded and written to disk platter 516.

It should be noted that storage system 500 can be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such storage system 500, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

In addition, it should be noted that storage system 500 can be modified to include solid state memory that is used to store data in addition to the storage offered by disk platter 516. This solid state memory may be used in parallel to disk platter 516 to provide additional storage. In such a case, the solid state memory receives and provides information directly to read channel circuit 502. Alternatively, the solid state memory can be used as a cache where it offers faster access time than that offered by disk platter 516. In such a case, the solid state memory can be disposed between interface controller 506 and read channel circuit 502 where it operates as a pass through to disk platter 516 when requested data is not available in the solid state memory or when the solid state memory does not have sufficient storage to hold a newly written data set. Based upon the disclosure provided herein, one of ordinary skill in the art will recognize a variety of storage systems including both disk platter 516 and a solid state memory.

Turning to FIG. 6, a wireless communication system 600 or data transmission device including a receiver 604 with a speculative bit error rate calculator is shown in accordance with some embodiments of the present invention. The transmitter 602 is operable to transmit encoded information via a transfer medium 606 as is known in the art. The encoded data is received from transfer medium 606 by receiver 604. Receiver 604 incorporates a speculative bit error rate calculator to speculatively calculate the bit error rate as data is decoded. Such speculative bit error rate calculation can be implemented consistent with the disclosure above in relation to FIGS. 1-3. In some embodiments, the speculative bit error rate calculation can be performed consistent with a process disclosed above in relation to FIG. 4.

Turning to FIG. 7, another storage system 700 is shown that includes a data processing circuit 710 having a speculative bit error rate calculator in accordance with one or more embodiments of the present invention. A host controller circuit 706 receives data to be stored (i.e., write data 702). This data is provided to data processing circuit 710 where it is encoded using an encoder such as, but not limited to, a low density parity check encoder. The encoded data is provided to a solid state memory access controller circuit 712. Solid state memory access controller circuit 712 can be any circuit known in the art that is capable of controlling access to and from a solid state memory. Solid state memory access controller circuit 712 formats the received encoded data for transfer to a solid state memory 714. Solid state memory 714 can be any solid state memory known in the art. In some embodiments of the present invention, solid state memory 714 is a flash memory. Later, when the previously written data is to be accessed from solid state memory 714, solid state memory access controller circuit 712 requests the data from solid state memory 714 and provides the requested data to data processing circuit 710. In turn, data processing circuit 710 decodes the received data using a decoder such as, but not limited to, a layer low density parity check decoder. As the decoding is performed, a speculative bit error rate calculator speculatively calculates the bit error rate based on the hard decisions from the decoder, updating the bit error rate layer by layer and iteration by iteration, so that when a codeword converges in the decoder, the bit error rate calculation is complete. Such speculative bit error rate calculation can be implemented consistent with the disclosure above in relation to FIGS. 1-3. In some embodiments, the speculative bit error rate calculation can be performed consistent with a process disclosed above in relation to FIG. 4. The decoded data and bit error rate are provided to host controller circuit 706 where the data is passed on as read data 704.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, embodiments of the present invention provide novel systems, devices, methods and arrangements for speculative bit error rate calculation during decoding. While detailed descriptions of one or more embodiments of the invention have been given above, various alternatives, modifications, and equivalents will be apparent to those skilled in the art without varying from the spirit of the invention. Therefore, the above description should not be taken as limiting the scope of embodiments of the invention which are encompassed by the appended claims.

What is claimed is:

1. An apparatus for calculating bit error rate, comprising:
a data decoder operable to iteratively decode received data to yield decoded data; and
a speculative bit error calculator operable to calculate a bit error rate based on the decoded data and the received data while the data decoder is decoding the received data, wherein the bit error rate is updated with each decoding iteration in the data decoder.

2. The apparatus of claim 1, wherein the data decoder comprises a low density parity check decoder.

3. The apparatus of claim 1, wherein the speculative bit error calculator comprises a delta calculator operable to calculate a delta value based on an error count for a current decoding iteration and a previous decoding iteration.

4. The apparatus of claim 3, wherein the speculative bit error calculator further comprises a register operable to store the error count for the previous decoding iteration.

5. The apparatus of claim 4, wherein the data decoder comprises a layered low density parity check decoder operable to decode a codeword layer by layer, and wherein the register comprises a multi-layer register operable to store the error count for each layer of the previous decoding iteration.

6. The apparatus of claim 3, wherein the speculative bit error calculator further comprises a bit error rate accumulator operable to store the bit error rate, wherein the bit error rate is updated by the delta value each time the delta value is calculated.

7. The apparatus of claim 3, wherein the speculative bit error calculator further comprises a detector operable to calculate the error count for the current decoding iteration based on a difference between the decoded data and the received data.

8. The apparatus of claim 7, wherein the detector comprises an XOR gate for each of a plurality of bits in the decoded data operable to identify when a bit in the decoded data differs from a corresponding bit in the received data.

9. The apparatus of claim 7, wherein the detector is operable to differentiate between multiple types of errors.

10. The apparatus of claim 9, wherein the detector is operable to calculate the error count for a first type of error in which a 1 was expected based on the decoded data but a 0 was received in the received data, and a second type of error in which a 0 was expected based on the decoded data but a 1 was received in the received data.

11. The apparatus of claim 7, further comprising a per iteration bit error calculator operable to convert the error count to a binary representation from a unary representation.

12. The apparatus of claim 1, wherein the decoder is implemented as an integrated circuit.

13. The apparatus of claim 1, wherein the decoder is incorporated in a storage device.

14. The apparatus of claim 1, wherein the decoder is incorporated in a transmission system.

15. A method of calculating a bit error rate, comprising:
decoding a layer of received data in a layered low density parity check decoder to yield decoded data for the layer;
calculating a layer bit error rate based on the decoded data and the received data;
calculating a delta value based on the layer bit error rate and a previous iteration layer bit error rate;
updating a bit error rate accumulator based on the delta value; and
outputting the bit error rate from the bit error rate accumulator when the decoded data converges in the layered low density parity check decoder.

16. The method of claim 15, further comprising storing the layer bit error rate in a layer register for use in calculating the delta value in a next decoding iteration.

17. The method of claim 15, wherein updating the bit error rate accumulator comprises subtracting the delta value from the bit error rate in the bit error rate accumulator and storing a result in the bit error rate accumulator.

18. The method of claim 15, wherein calculating the layer bit error rate comprises calculating an error rate of each of a first type of error in which a 1 was expected based on the decoded data but a 0 was received in the received data, and a second type of error in which a 0 was expected based on the decoded data but a 1 was received in the received data.

19. A storage system comprising:
a storage medium;
a data decoder operable to iteratively decode received data from the storage medium to yield decoded data; and
a speculative bit error rate calculator operable to calculate a bit error rate as the data decoder is iteratively decoding the received data, comprising:
a failed expectation detector operable to determine a difference between the received data and the decoded data for each decoding iteration;
a register operable to store the difference;
a delta calculator operable to calculate a delta between the difference and a copy of the difference for a previous decoding iteration; and
a bit error rate accumulator operable to store a speculative bit error rate, wherein the speculative bit error rate is updated by the delta after each of the decoding iterations.

20. The storage system of claim 19, wherein the data decoder comprises a layered quasi-cyclic low density parity check decoder, wherein the difference is calculated for each layer in a decoding iteration, and wherein the register is operable to store the difference for each of the layers.
